(19) United States
(12) Patent Application Publication
(10) Pub. No.: US 2020/0196062 A1
(43) Pub. Date: Jun. 18, 2020

(54) Loudspeaker

(71) Applicant: AAC Acoustic Technologies (Shenzhen) Co., Ltd., Shenzhen (CN)

(72) Inventor: Tong Zhang, Shenzhen (CN)

(21) Appl. No.: 16/699,143

(22) Filed: Nov. 29, 2019

(30) Foreign Application Priority Data
Dec. 12, 2018 (CN) 201822091381.5

(51) Int. Cl. H04R 9/04; H04R 9/06; H04R 31/00

(52) U.S. Cl. CPC H04R 9/046; H04R 31/003; H04R 9/06

(57) ABSTRACT

A loudspeaker provided by the present disclosure, includes a frame, a diaphragm fixed to the frame, a voice coil positioned below the diaphragm. The diaphragm includes a dome and a suspension extending from the dome. The dome includes a protruding portion and a peripheral portion arranged around the protruding portion. By the configuration of the dome, the strength of the dome is enhanced, and the split vibration during high frequency is weakened, and the high-frequency performance of the loudspeaker is improved.

### FIELD OF THE PRESENT DISCLOSURE

The present disclosure relates to the field of electroacoustic transducers, more particularly to a loudspeaker used in a mobile electronic device.

### DESCRIPTION OF RELATED ART

With the arrival of the mobile internet era, the number of intelligent mobile equipment rises continuously. In a plurality of mobile equipment, the mobile phone is undoubtedly the most common, most portable mobile terminal equipment. At present, the functions of the mobile phone and the functions of the mobile phone are various. One of the functions of the mobile phone is a high-quality music function, and a loudspeaker, in the mobile phone is one of the necessary component for achieving the high-quality music performance.

A diaphragm is used as a core sound production part of the loudspeaker. The design of the core sound production part directly affects the acoustic performance of the loudspeaker. The diaphragm usually comprises a dome located at a central position, and a suspension surrounding the dome. The vibration of the diaphragm is mainly based on the vibration of the dome, and the amplitude/frequency of the dome is larger than the vibration amplitude/frequency of the suspension. Thus, the dome is an important component for reflecting the acoustic effect of the loudspeaker. The ideal state is that all positions of the dome can be vertically straight during the vibration process, and the dome is a complete rigid body with no split vibration. However, the dome in the related art is a flat plate structure with equal thickness. During high-frequency vibration, the dome can be distorted and deformed, which cannot provide good acoustic performance. Especially when the size of the loudspeaker is large, the voice coil is difficult to play a good role in supporting the dome, so that the high-frequency sensitivity and the tone quality of the loudspeaker are influenced.

Therefore, it is necessary to provide an improved loudspeaker to solve the problems mentioned above.

### SUMMARY OF THE PRESENT DISCLOSURE

One of the primary objects of the present disclosure is to provide a loudspeaker with reduced split vibration and improved high frequency-resonance performance.

Accordingly, a loudspeaker is provided, and comprises:

a frame;

a diaphragm fixed to the frame;

a voice coil positioned below the diaphragm for driving the diaphragm to vibrate; wherein

the diaphragm comprises a dome positioned in a central portion thereof, and a suspension surrounding the dome;

the dome comprises a protruding part positioned in the central portion and a peripheral part disposed around the protruding part.

As, an improvement, the protruding portion protrudes from the peripheral portion in a direction away from the voice coil.

As, an improvement, the protruding portion protrudes from the peripheral portion in a direction toward the voice coil.

As, an improvement, a protruding direction of the protruding part is same to a protruding direction of the suspension.

As, an improvement, a protruding direction of the protruding part is different from a protruding direction of the suspension.

As, an improvement, the protruding portion is square, round or oval.

As, an improvement, the suspension is of an annular hollow structure.

As, an improvement, the dome is assembled with the hollow part of the suspension.

As, an improvement, the dome and the suspension are separated formed and connected with each other, the suspension comprises a connecting part close to the dome for being fixedly connected with the peripheral part.

As, an improvement, the dome and the suspension are integrally formed.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is an isometric and exploded view of a loudspeaker in accordance with an exemplary embodiment of the present disclosure.

FIG. 2 is a cross-sectional view of the loudspeaker in FIG. 1.

FIG. 3 is an isometric view of a dome of a diaphragm of the loudspeaker.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

In order to solve the problem that the dome generates split vibration due to insufficient strength, the structure of the dome in the present disclosure is improved, as follows:

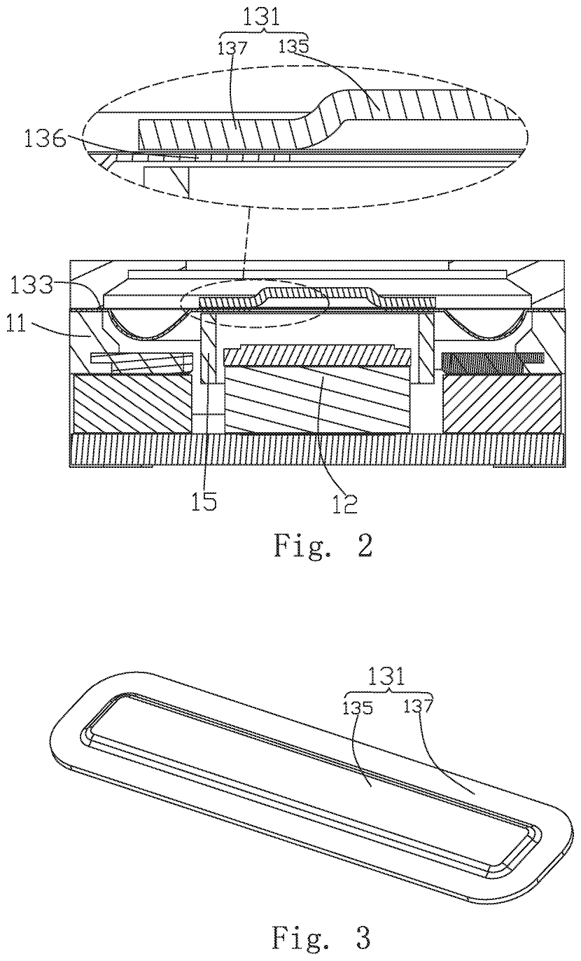

A loudspeaker, in accordance with an exemplary embodiment of the present disclosure, includes a frame 11, a diaphragm 13 fixed to the frame 11, a voice coil 15 located below the diaphragm 13 and used for driving the diaphragm 13 to vibrate, and a magnetic circuit system 12 located below the diaphragm 13 and fixed to the frame 11. In the embodiment, the dome 131 includes a protruding portion 135 located in a central region and a peripheral portion 137 disposed around the protruding portion 135. As shown in FIGS. 2-3, the protruding portion 135 extends upward from the peripheral portion 137 away from the voice coil 15. The protruding portion 135 is connected with the peripheral portion 137 through a smooth transition surface or an inclined surface, and can also be connected in a right-angled connection manner, but is not limited thereto in other embodiments. The protruding portion 135 protrudes downward in a direction close to the voice coil 15. Therefore, the dome 131 has a concave-convex structure, so that the strength of the dome 131 can be enhanced, the split vibration during high frequency is effectively inhibited, and the high-frequency performance of the product is improved.

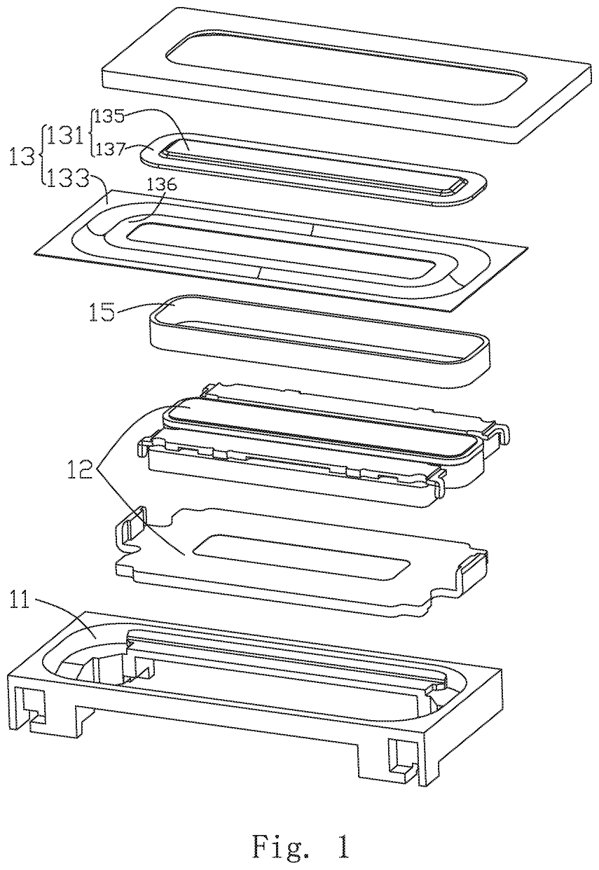

In this embodiment, the diaphragm 13 is rectangular. The suspension 133 is of an annular hollow structure. The dome 131 is combined with the hollow portion of the suspension 133. The dome 131 and the suspension 133 are two separated components connected with each other. The suspension 133 includes a connecting portion 136 adjacent to the dome 131, for being fixedly connected with the peripheral portion 137. Specifically, referring to FIG. 1, the suspension 133 and the dome 131 can also be integrally formed. Further, the dome 131 is rectangular, the suspension 133 is in an annular shape, and the dome 131 can be oval, polygonal and other shapes. The protruding part 135 is a rectangle with round corners, and can also be square, oval or other shapes.

In addition, a protruding direction of the protruding portion 135 is different from a protruding direction of the suspension 133, but is not limited thereto. The protruding direction of the suspension 133 may be the same as the protruding direction of the protruding portion 135.

Compared with the prior art, the loudspeaker provided by the invention has the advantages that the protruding part is arranged in the central area of the dome, so that the strength of the dome is enhanced by the spherical top of the concave part, by which the split vibration during high frequency is weakened, and the high-frequency performance of the loudspeaker is improved. As a result, the listening feeling is improved, the acoustic performance of the product is improved, and the reliability is effectively improved.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A loudspeaker, comprising:
a frame;
a diaphragm fixed to the frame;
a voice coil positioned below the diaphragm for driving the diaphragm to vibrate; wherein
the diaphragm comprises a dome positioned in a central portion thereof, and a suspension surrounding the dome;
the dome comprises a protruding part positioned in the central portion and a peripheral part disposed around the protruding part.

2. The loudspeaker as described in claim 1, wherein the protruding portion protrudes from the peripheral portion in a direction away from the voice coil.

3. The loudspeaker as described in claim 1, wherein the protruding portion protrudes from the peripheral portion in a direction toward the voice coil.

4. The loudspeaker as described in claim 2, wherein a protruding direction of the protruding part is same to a protruding direction of the suspension.

5. The loudspeaker as described in claim 3, wherein a protruding direction of the protruding part is same to a protruding direction of the suspension.

6. The loudspeaker as described in claim 2, wherein a protruding direction of the protruding part is different from a protruding direction of the suspension.

7. The loudspeaker as described in claim 3, wherein a protruding direction of the protruding part is different from a protruding direction of the suspension.

8. The loudspeaker as described in claim 2, wherein the protruding portion is square, round or oval.

9. The loudspeaker as described in claim 3, wherein the protruding portion is square, round or oval.

10. The loudspeaker as described in claim 1, wherein the suspension is of an annular hollow structure.

11. The loudspeaker as described in claim 7, wherein the dome is assembled with the hollow part of the suspension.

12. The loudspeaker as described in claim 1, wherein the dome and the suspension are separated formed and connected with each other, the suspension comprises a connecting part close to the dome for being fixedly connected with the peripheral part.

13. The loudspeaker as described in claim 1, wherein the dome and the suspension are integrally formed.
